(19) United States
(12) Patent Application Publication
(10) Pub. No.: US 2006/0101495 A1
(43) Pub. Date: May 11, 2006

(54) Device evaluation using media access control emulator

(76) Inventors: William Yoshida, Westampton, NJ (US); Ramprasad Pothukanuri, Plainsboro, NJ (US)

Correspondence Address: MCDERMOTT WILL & EMERY LLP, 600 13TH STREET, N.W., WASHINGTON, DC, 20005-3096, US

(21) Appl. No.: 10/981,761

(22) Filed: Nov. 5, 2004

(51) Int. Cl. H04N 7/18; H04N 7/173

(52) U.S. Cl. 725/78; 725/74; 725/80; 725/100

(57) ABSTRACT

A simulation system is provided for emulating media access control (MAC) messages that are exchanged between a headend controller and one or more set top boxes. The simulation system can be used to test the low-level functionality of the set top boxes. The system includes a headend simulator that includes a MAC emulator state machine. The MAC emulator state machine implements a cable MAC over an Ethernet network interface.

### TECHNICAL FIELD

This invention relates generally to a simulation system for a communication network, and more particularly, to evaluating the performance of one or more devices using a media access control emulation system.

### BACKGROUND

Conventionally, set top boxes (STBs) are deployed by video service providers to provide customers with access to audio/video programming, such as cable television. With the growth of the Internet, set top boxes are increasingly being using as service access points for broadband data services. Industry standards, such as the Data-over-cable Service Interface Specifications (DOCSIS) (available from Cable Television Laboratories, Inc. of Louisville, Colo.) have been developed to facilitate the deployment of interoperable networks. The DOCSIS specifications include descriptions of the media access control (MAC) layer functionality that is required in order to be compliant with the specification, and therefore interoperable with other devices or system entities.

One problem with the development of STBs, however, is efficiently testing or evaluating the performance of the embedded MAC layer functionality. FIG. 1 illustrates a conventional network architecture that can be used to evaluate STB performance. FIG. 1 shows a hybrid fiber coax (HFC) network 100 with a headend 105 and a STB 110 coupled thereto. A radio frequency (RF) sniffer 115 is also coupled to a coax portion of the HFC network 100 to observe the communications between the headend 105 and the STB 110. The RF sniffer 115 collects and analyzes data to determine whether the STB responds correctly to a plurality of cable MAC messages. For example, the RF sniffer 115 determines whether the STB generates and responds to MAC layer communications according to the DOCSIS protocol.

A limitation of the system illustrated in FIG. 1, however, is the ability of the RF sniffer 115 to observe all the appropriate network traffic. In the HFC network 100, the forward and reverse path data channels are frequency agile. More specifically, the up converter 120 can provide one or more 6 MHz downstream data channels within a range of frequencies (e.g., 91-857 MHz). To perform an effective and comprehensive test, the RF sniffer 115 must be capable of receiving all the data channels (either concurrently or individually), which typically involves capturing much of the spectrum used for forward and reverse path communications. Furthermore, the RF sniffer 115 must be capable of transmitting or generating the specific types of errors needed to test the STBs on each of the data channels. Thus, the RF sniffer 115 is typically complex to operate and costly to manufacture.

Another problem with conventional techniques is that they are inapplicable to various types of networks. FIG. 2 illustrates a conventional video streaming architecture. The illustrated architecture uses IEEE 1394 media 205 to transport audio and video data from a stream server 210 to the STB 215. A conventional network analyzer, such as the RF sniffer 115, is not configured for the IEEE 1394 MAC layer. Furthermore, in a satellite or terrestrial broadcast network, the RF sniffer 115 is impractical for analyzing the data communications because there is no convenient point at which to collect and analyze the forward and reverse path data streams.

What is needed is media access control emulator that provides flexible and configurable evaluation of STB performance without particular network architecture constraints.

### SUMMARY OF THE INVENTION

In one aspect, a headend simulator system is provided for evaluating a target device coupled to a local area network. The headend simulator includes a first network interface and an emulator state machine. The first network interface includes a protocol stack and is configured to be coupled to the local area network. The emulator state machine is operatively coupled to the protocol stack and is configured to communicate with the target device over the local area network by emulating at least one media access control message, such as messages associated with a DOCSIS-compliant MAC layer.

In another aspect, a method is provided for emulating media access control communications in a headend simulator system. The method includes establishing a connection with a set top box, performing a synchronization transaction with the set top box, and sending at least one protocol message to the set top box. The method also forwards data from a first protocol stack to a second protocol stack and observes the forwarded data to evaluate or test the set top box.

In a further aspect, a set top box is provided for communicating with a headend controller (or simulation system). The set top includes a network interface that is operatively coupled to a local area network. The network interface may also be coupled to customer premises equipment, such as a computing device. The network interface provides data communication with the headend controller. The set top box also includes an emulator media access control state machine that observes the data communications with the headend and a media access control state machine that sends and receives at least one media access control message.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 is a diagram illustrating a conventional hybrid fiber coax network.

FIG. 2 is a diagram illustrating a conventional video streaming architecture using IEEE 1394 media.

FIG. 3 is a diagram illustrating a headend simulator according to an embodiment of the present invention.

FIG. 4 is a diagram illustrating a headend simulator according to another embodiment of the present invention.

FIG. 5 is a block diagram illustrating further details of the system of FIG. 3.

FIG. 6 is a diagram illustrating protocol stacks according to an embodiment of the present invention.

FIG. 7 is a diagram illustrating a protocol structure according to an embodiment of the present invention.

FIG. 8 is a flowchart illustrating a method for evaluating a target device according to an embodiment of the present invention.

FIG. 9 is a state diagram for a media access control emulator according to an embodiment of the present invention.

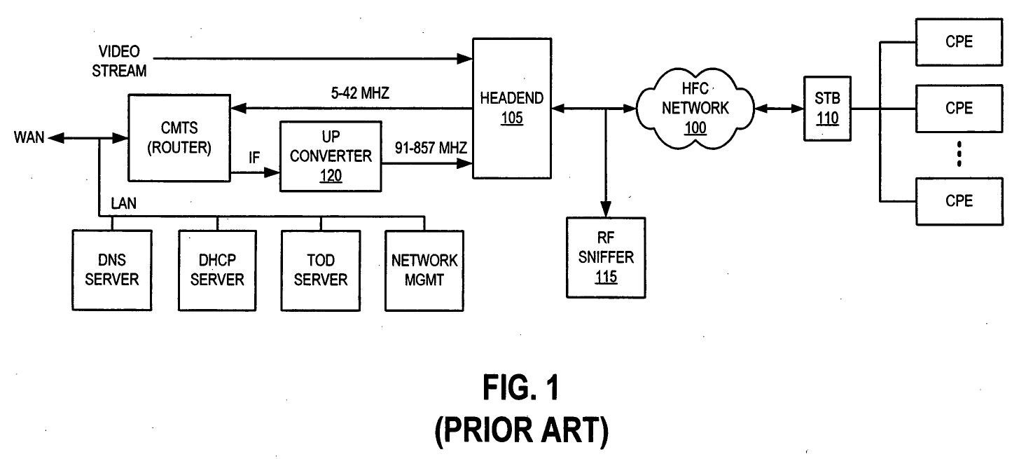

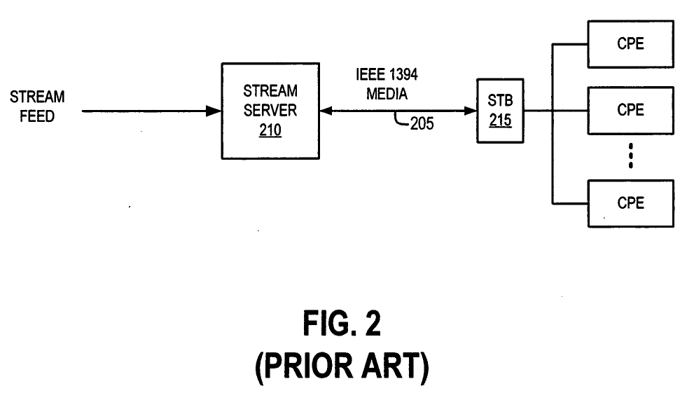

### DETAILED DESCRIPTION OF THE EMBODIMENTS

The present invention is now described more fully with reference to the accompanying figures, in which several embodiments of the invention are shown. One skilled in the art will recognize that methods, apparatus, systems, data structures, and computer readable media implement the features, functionalities, or modes of usage described herein. For instance, an apparatus embodiment can perform the corresponding steps or acts of a method embodiment.

A. Overview

In an embodiment, a system is provided for simulating media access control (MAC) messages that are exchanged between a headend controller and one or more set top boxes. For example, in a hybrid fiber coax network, a set top box (such as a cable modem) typically exchanges MAC messages according to the DOCSIS protocol. However, the cable modem MAC (or DOCSIS MAC) protocol differs from the conventional ethernet MAC protocol. The system emulates the MAC layer with Ethernet to test the functionality of the higher layers including the Internet Protocol (IP) layer. One advantage of the present invention is reduced development time for the set top boxes. The simulation system provides convenient visibility or observation of the network communications between the headend and the set top boxes. This enables easier debugging and real-world performance characterization of the set top boxes.

As one skilled in the art will appreciate, other MAC protocols can be used. For example, the MAC implementation described by the Digital Audio Visual Council (DAVIC) specification (which is available from the Digital Audio Visual Council of Switzerland) can be used in an embodiment of the invention.

In an embodiment, MAC layer functionality is emulated using a software state machine. The emulator state machine provides flexibility, as it can be adapted to the particular communication system in which the set top boxes will be deployed. For example, a DOCSIS emulation may be suitable for a conventional hybrid fiber coax network topology, which a Packet Reservation Multiple Access (PRMA) emulation may be suitable for a satellite-based data service. In either case, for testing purposes, the physical layer implementation can be ethernet.

B. Simulator Architecture

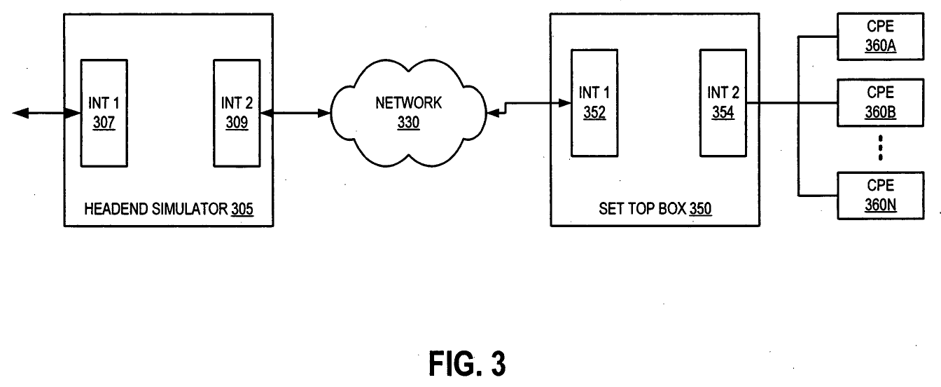

FIG. 3 is a diagram illustrating a headend simulator according to an embodiment of the present invention. The illustrated embodiment includes a headend simulator 305, a network 330, and a set top box (STB) 350. The headend simulator 305 includes a first and second network interfaces 307, 309. The STB 350 also includes a first and second network interfaces 352, 354. The network interfaces 307, 309, 352, 354 are Ethernet interfaces, although one skilled in the art will appreciate that other interfaces may be used.

The headend simulator 305 and the STB 350 are communicatively coupled via the network 330. More specifically, the second network interface 309 of the headend simulator 305 is coupled to a first network port, and the first network interface 352 of the STB 350 is coupled to a second network port. As one skilled in the art will appreciate, routers or other networking equipment may be used to physically communicate the data on the network 330. The network 330 represents a logical abstraction of a conventional data communication network, such as an Ethernet based local area network.

The first network interface 307 of the headend simulator 305 can be communicatively coupled to another network, such as a wide area network (not shown). Example wide area networks include the Internet. The second network interface 354 of the STB 350 is communicatively coupled to one or more customer premises equipments (CPEs) 360A-N. One skilled in the art will appreciate that the CPE represents a computing device, display device, telephony device, router, or other functionality that is used by a customer to produce or consume data.

The STB 350 may be more generically referred to as an embedded device and is not limited to the data communication functionality described herein. For example, the STB 350 may also include audio/video receivers or decoders. Additionally, the STB 350 and other modules described herein need not be discrete and physically separate components. For example, the features or functions of the STB 350 may be integrated into another device, such as a television.

The headend simulator 305 and the STB 350 include MAC emulators that are used to simulate the communications environment. These simulations can test the functionality of the STB 350 and its interactions with the network 330. In an embodiment in which the STB 350 provides data communication service for the CPEs 360A-N, the headend simulator 305 can evaluate the efficiency and throughput of the data communications to and from the wide area network. The headend simulator 305 may also introduce erroneous data into the packet flows to test how the STB 350 responds or recovers. Further details regarding the operation of the system are described below.

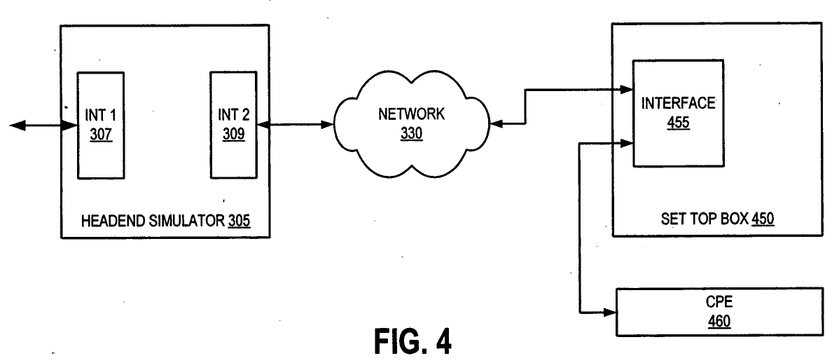

FIG. 4 is a diagram illustrating a headend simulator according to another embodiment of the present invention. The illustrated embodiment includes the headend simulator 305 and the network 330 described above and with reference to FIG. 3. However, this embodiment illustrates a variation in the architecture of the STB 450. The STB-450 includes a network interface 455 that is shared with the network 330 and the CPE 460. In one implementation, an Ethernet tunnel port is used to share the network interface 455.

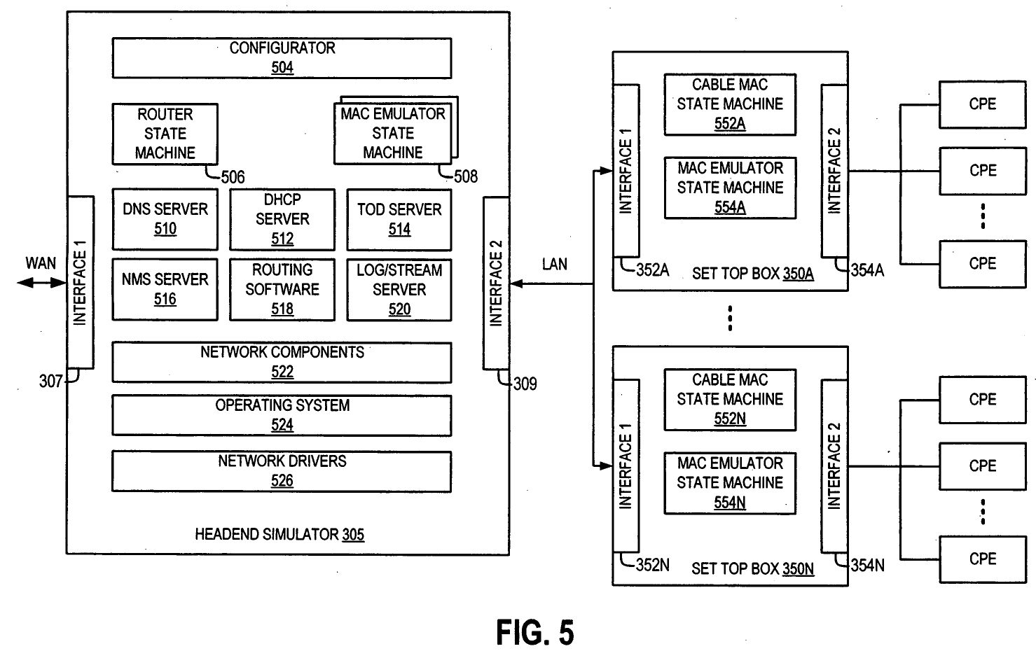

FIG. 5 is a block diagram illustrating further details of the system of FIG. 3. The headend simulator 305 includes a number of software modules that perform various functions or implement certain features. One skilled in the art will appreciate that the headend simulator 305 may be implemented with a conventional computing device. The software modules described herein can be implemented with program instructions that are executed by a processor.

The headend simulator 305 includes a configurator 504 which provides an interface for an entity (such as a user) to set operational parameters for one or more software modules. The parameters may be set interactively using a graphical user interface or programmatically using an application programming interface.

A router state machine 506 directs data that is received from the wide area network on the first network interface 307 to the destination STB 350. The routing software 518 is operatively coupled to the router state machine 506 to provide routing tables or other configuration information. In addition to managing the communications to the STBs 350A-N, the headend simulator 305 functions as a data gateway to route packets to/from the wide area network (e.g., the internet).

A MAC emulator state machine 508 communicates MAC messages with the STB 350. In one embodiment, an instance of the MAC emulator state machine 508 is executed for each STB 350 that is under test as a target device. For example, the illustrated embodiment includes N STBs 350A-N. Therefore, the headend simulator 305 executes N instances of the emulator state machine 508, each instance being associated with one of the target devices. Although multiple instances are used in the architecture described herein, one skilled in the art will appreciate that in another software architecture, fewer or more state machine instances may be used.

A MAC emulator state machine 554 also executes on the STB 350. The MAC emulator state machine 554 provides visibility into the MAC layer data communications so that these communications can be analyzed. The MAC emulator state machine 554 functions in conjunction with the cable MAC state machine 552. In the illustrated exemplary embodiment, the cable MAC state machine implements a conventional DOCSIS-compliant MAC layer.

The domain name server (DNS) 510 is a software module that provides conventional DNS services, such as IP address resolution for the STBs 350A-N. Likewise, the dynamic host configuration protocol (DHCP) server is a software module that provides conventional DHCP services, such as IP address and gateway assignment.

The time of day (TOD) server 514 is used to provide a time reference to the STBs 350A-N for synchronization functions. The network management server (NMS) 516 is a software module that collects and analyzes information about the data traffic flows between the headend simulator 305 and the STBs 350A-N. The NMS 516 operates in conjunction with the configurator 504 to provide a user or programming interface for the system.

The log/stream server 520 captures the MAC layer data from the protocol stacks that are associated with the network interfaces 307, 309. The log/stream server 520 is functionally similar to a sniffer device; however, the log/stream server 520 captures the MAC layer information from a software interface rather than acquiring the data indirectly from the communications media. The log/stream server 520 can provide this data in real-time or to other system entities, such as the NMS 516 or to remote entities via the wide area network. In addition, the log/stream server 520 can store the MAC layer data for later analysis. One skilled in the art will note that the software architecture illustrated in FIG. 5 is not limited to analyzing MAC layer communications. The log/stream server 520 can be configured by the configurator 504 to capture any data that flows into or out of the headend simulator 305.

As described in further detail below and with reference to FIG. 7, the log/stream server 520 can also store the error messages communicated from the STB 350. More specifically, the MAC emulator state machine 508 receives the error code messages, and the log/stream server 520 stores the error code messages. In certain embodiments, the log/stream server 520 also includes a decoding system to decode the error code messages.

The network components 522 represent the software protocol stacks that implement the various layers of the communication protocols. The operating system 524 is a conventional operating system for a general purpose or special purpose computing device that is dependent on the hardware architecture used to implement the headend simulator 305.

The network drivers 526 represent a software abstraction layer that communicates with the physical hardware associated with the network interfaces 307, 309. For example, in an Ethernet embodiment, the network drivers 526 provide an interface between the operating system 524 and the Ethernet physical layer transceivers.

C. Protocol Stacks

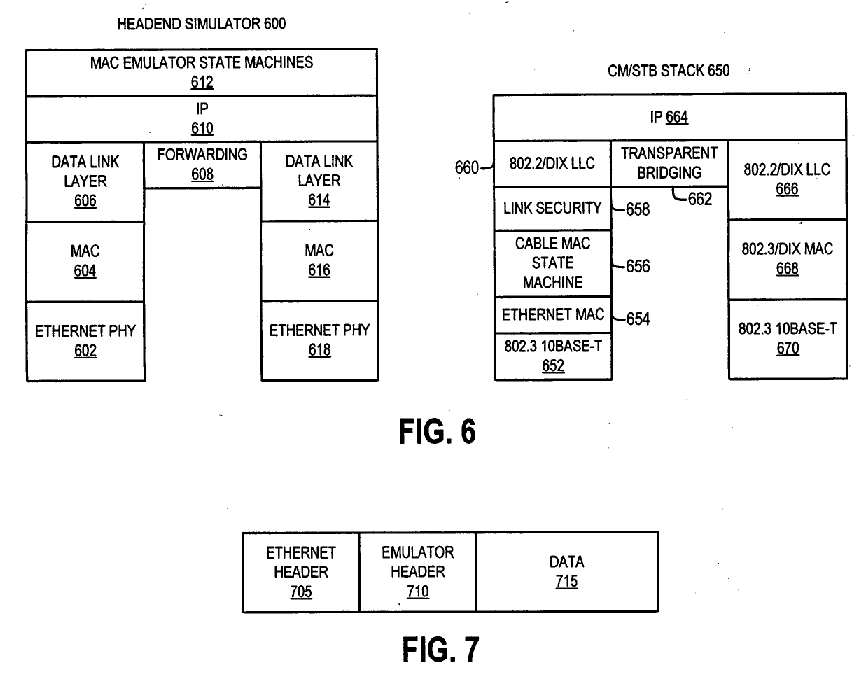

FIG. 6 is a diagram illustrating protocol stacks according to an embodiment of the present invention. The illustrated embodiment includes a Ethernet-based protocol stacks for the headend simulator 600 and the STB 650. Of course, other types of protocols may also be used. On a first of the network interfaces the headend simulator protocol stack 600 includes an Ethernet physical layer 602, a MAC layer 604, a data link layer 606. On a second of the network interfaces the headend simulator protocol stack 600 includes a data link layer 614, a MAC layer 616, and a Ethernet physical layer 618.

A forwarding layer 608, an IP layer 610, the MAC emulator state machine 612 bridge the first and the second network interfaces. In a DOCSIS cable modem embodiment, the MAC emulator state machine 612 emulates the functionality of a DOCSIS cable MAC layer, which would ordinarily be placed in the protocol stack where MAC layer 616 is located. In this embodiment, the MAC layer 616 is a conventional Ethernet MAC for facilitating the observation and analysis of the MAC messages. The MAC emulator state machine 612 communicates with a corresponding state machine resident in the STB via a protocol structure that is further described below and with reference to FIG. 7.

For the STB protocol stack 650, the media-specific physical layer (such as DOCSIS cable) has been replaced with a conventional Ethernet 802.3 physical layer 652 and MAC layer 654. The cable MAC state machine 656 communicates MAC messages with the MAC emulator state machine 612 on the headend simulator. The STB protocol stack 650 includes other conventional layers associated with the first network interface, such as link security 658, logical link control 660. A bridging layer 662 and IP layer 664 couple the first and second network interfaces. The CPE side of the protocol stack also includes conventional Ethernet layers, such as logical link control 666, and Ethernet 802.3 MAC 668 and physical layer 670.

FIG. 7 is a diagram illustrating a protocol structure according to an embodiment of the present invention. The illustrated protocol data unit includes an Ethernet header 705, an emulator header 710, and a data payload 715. The general format of the protocol structure conforms with a conventional Ethernet frame, although one skilled in the art will recognize that the emulator header 710 is an additional field that is placed within the payload of a conventional frame. The emulator header 710 is used to communicate information from the STB 350 to the headend simulator 305. For example, in the forward path (i.e., data flow from the headend simulator 305 to the STB 350), the emulator header 710 may include information to identify the particular headend simulator 305. The emulator header 710 may also. define commands for the STB 350 to perform specific tasks to test the system. In the reverse path, the emulator header 710 can be used to convey an error code from the STB 350 to the headend simulator 305. An example error code includes a SYNC reply (Identity reply) if the STB 350 reaches a maximum number of state machines.

In certain embodiments, the emulator header 710 includes information to enable the STB 350 that is under test to detect messages associated with the headend simulator 305 and to process those packets. Otherwise, the packets need not be routed to the MAC emulator state machine 554. The emulator header 710 also includes the error code messages that are to be communicated to the log/stream server 520 of the headend simulator 305. Table 1 illustrates an example list of error codes. As one skilled in the art will appreciate, the error codes may vary depending on the test environment or other characteristics.

TABLE 1

| Error Code | Description |
|---|---|
| 0 | Okay_Success |
| 1 | Reject_Other |
| 2 | Reject Unrecognized_Config_Setting |
| 3 | Reject_Temporary_Resource |
| 4 | Reject_Permenent_Admin |
| 5 | Reject_Not_Owner |
| 6 | Reject_Sf_Not_Found |
| 7 | Reject_Sf_Exists |
| 8 | Reject_Req_Param_Not_Present |
| 9 | Reject_Header_Suppression |
| 10 | Reject_Unkn_Trans_Id |
| 11 | Reject_Auth_Failure |
| 12 | Reject_Add_Aborted |
| 13 | Reject_Multiple_Errors |
| 14 | Reject_Classifier_Not_Found |
| 15 | Reject_Classifier_Exists |
| 16 | Reject_Phs_Rule_Not_Found |
| 17 | Reject_Phs_Rule_Exists |
| 18 | Reject_Dup_Ref_Id |
| 19 | Reject_Multiple_Us_Sf |
| 20 | Reject_Multiple_Ds_Sf |
| 21 | Reject_Classifier_For_Another_Sf |
| 22 | Reject_Phs_For_Another_Sf |
| 23 | Reject_Param_Invalid_For_Context |
| 24 | Reject_Authorization_Failure |
| 25 | Reject_Temp_Dcc |
| 180 | Depart |
| 181 | Arrive |
| 182 | Reject-Already_Arrive |
| 200 | Reject-Major-Service-Flow-Error |
| 201 | Reject-Major-Classifier-Error |
| 202 | Reject-Major-PHS-Rule-Error |
| 203 | Reject-Multiple-Major-Errors |
| 204 | Reject-Message-Syntax-Error |
| 205 | Reject-Primary-Service-Flow-Error |
| 206 | Reject-Message-Too-Big |
| 207 | Reject-Invalid-Modem-Capabilities |

D. Methodology

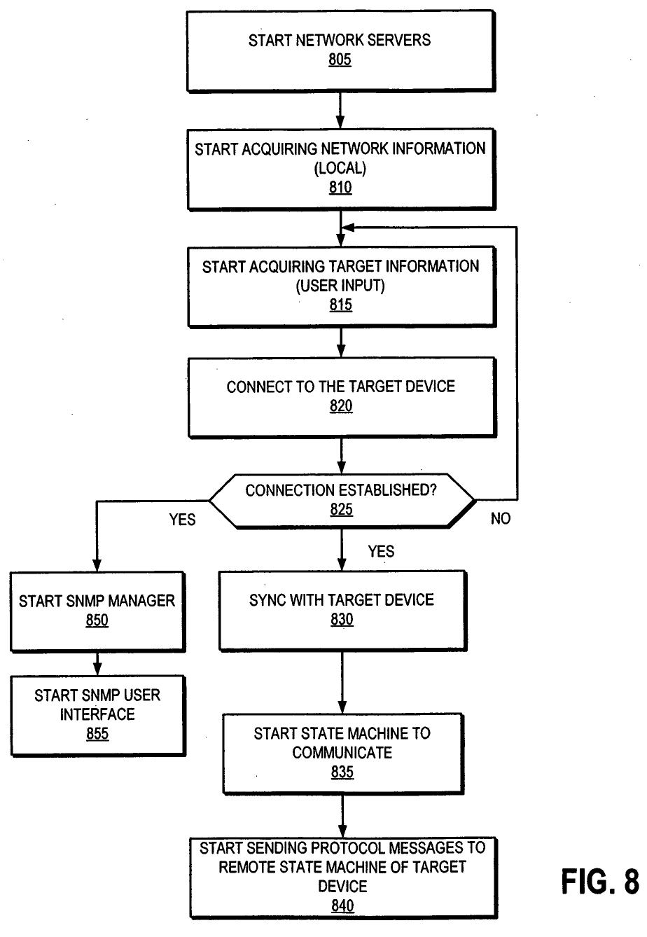

FIG. 8 is a flowchart illustrating a method for evaluating a target device according to an embodiment of the present invention. The headend simulator 305 executes the illustrated method to begin testing or performing performance evaluation of one or more of the STBs 350. The method begins with starting 805 the network servers. The network servers generally comprise the DNS 510, DHCP 512 , TOD 514, and log/stream server 520 described above and with reference to FIG. 5.

The method then acquires 810 local network information for the headend simulator 305. In this step, the headend simulator 305 learns the MAC addresses that correspond with the IP addresses (which are already known) for each of the devices to be tested.

The method also acquires 815 information about the one or more STBs 350 (i.e., target devices) that are to be tested. In one embodiment, the target devices have Ethernet MAC layers, so conventional address resolution protocol (ARP) messages can be used to learn the MAC addresses of the target devices.

After the target information has been acquired, the headend simulator 305 connects 820 to each of the target devices. If a connection is established 825, the method continues to steps 830 and 850. If a connection cannot be established, the method returns to step 815 to retry the acquiring 815 of target information.

In step 830, a SYNC is performed with the target devices. When the devices are in SYNC, the target devices accept the received message from MAC emulation system and respond with the reply to the received message once the MAC emulation system learns the MAC address of the target device.

In step 835, a state machine is started 835 to communicate with the target devices and protocol messages are sent 840 to the target devices. The state machines in the target devices receive the protocol messages and respond accordingly. In step 850, the headend simulator 305 starts 850 the NMS server 516 and its associated user interface 855.

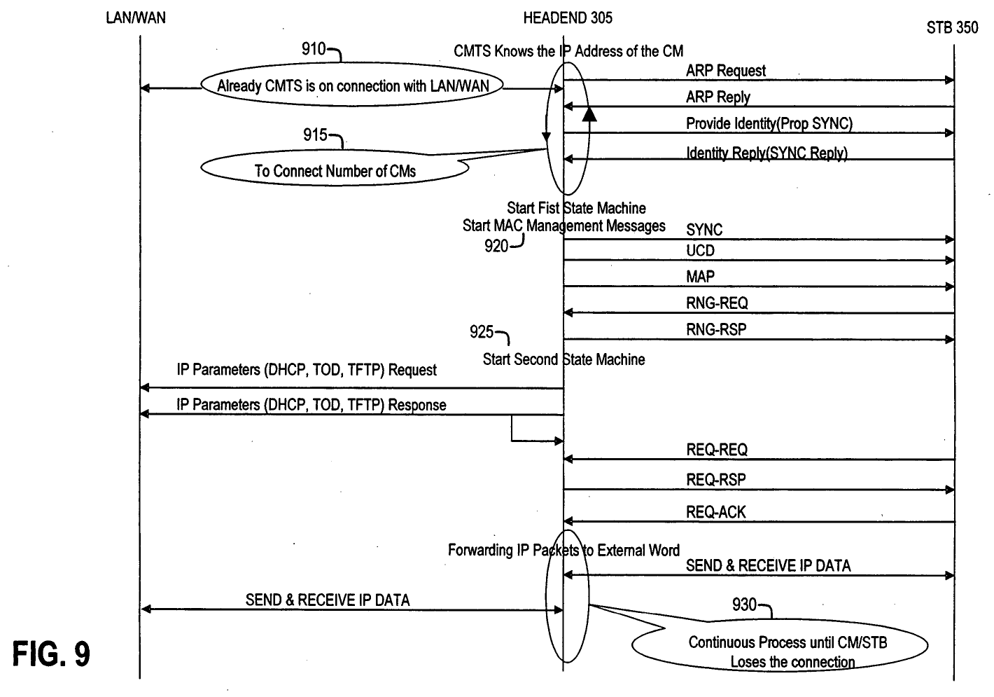

FIG. 9 is a state diagram for a media access control emulator according to an embodiment of the present invention. The illustrated state machine includes events that are associated with a DOCSIS cable modem embodiment. When the state machine starts, the cable modem termination system (CMTS) or router is connected with the headend simulator 305. The headend simulator 305 issues commands to the STBs 350 to connect 915 with one or more STBs.

After the STBs are connected, a first state machine is started 920 for communicating MAC management messages between the headend simulator 305 and the STBs 350. A second state machine 925 is used to perform an IP level configuration of the STBs 350. In the next state, the headend simulator forwards IP packets between the wide area network and the STBs. While the headend simulator 305 is sending and receiving data, it may also observe the MAC layer or other network layer messages. The data transfers continue 930 until the STB loses the connection. The information that the headend simulator 305 observed can be used, for example, to debug the protocol stack of the STB 350.

Furthermore, the headend simulator 305 can be configured to introduce erroneous messages into the data flow in order to evaluate how the STB 350 performs under certain conditions. For example, the headend simulator 305 may intentionally not respond correctly to a RNG-REQ command from the STB 350 to determine whether the STB 350 retries the command within an appropriate or standards-compliant time frame.

Having described embodiments of device evaluation using media access control emulator (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims and equivalents.

What is claimed is:

1. A headend simulator system for evaluating a target device coupled to a local area network, the system comprising:
a first network interface having a protocol stack and configured to be coupled to the local area network; and
a first emulator state machine operatively coupled to the protocol stack and configured to communicate with the target device over the local area network by emulating at least one media access control message.

2. The system of claim 1, further comprising:
a second network interface configured to be coupled to a wide area network; and
a router state machine operatively coupled to the protocol stack and configured to direct data from the target device to the wide area network.

3. The system of claim 2, further comprising:
a second emulator state machine operatively coupled to the protocol stack and configured to communicate with a second target device over the local area network by emulating at least one media access control message.

4. The system of claim 3, wherein the router state machine is further configured to direct data from the second target device to the wide area network.

5. The system of claim 1, further comprising:
a second emulator state machine operatively coupled to the protocol stack and configured to communicate with a second target device over the local area network by emulating at least one media access control message.

6. The system of claim 1, further comprising:
a domain name server module configured to provide domain name service for the target device.

7. The system of claim 1, further comprising:
a network management module operatively coupled to the first emulator state machine and configured to observe the at least one media access control message.

8. The system of claim 1, further comprising:
a time of day server module configured to provide time of day service for the target device.

9. The system of claim 1, further comprising:
a host configuration protocol server module configured to provide internet protocol address data to the target device.

10. The system of claim 1, further comprising:
a log module configured to store information about data flow from the protocol stack.

11. The system of claim 1, further comprising:
a configuration module operatively coupled to the first emulator state machine and configured to control at least one operational parameter.

12. The system of claim 1, wherein the first network interface comprises one of an ethernet interface and an IEEE 1394 interface.

13. The system of claim 1, wherein the at least one media access control message comprises a DOCSIS transaction.

14. The system of claim 1, wherein the first emulator state machine is further configured to evaluate the target device by providing at least one erroneous media access control message.

15. The system of claim 1, wherein the first emulator state machine is further configured to monitor the protocol stack for at least one of data throughput and data integrity.

16. The system of claim 1, wherein the first emulator state machine is further configured to simulate RF MAC messages using an ethernet MAC.

17. The system of claim 1, wherein the target device includes a protocol stack for communicating with the local area network.

18. A method for emulating media access control communications in a headend simulator system having a first protocol stack operatively coupled to a local area network and a second protocol stack operatively coupled to a wide area network, the method comprising:
establishing a connection with a set top box via the first protocol stack;
performing a synchronization transaction with the set top box responsive to the connection being established;
sending at least one protocol message to the set top box;
forwarding data from the first protocol stack to the second protocol stack; and
observing the forwarded data to evaluate the set top box.

19. The method of claim 18, wherein establishing a connection with a set top box via the first protocol stack comprises:
sending an address resolution request to the set top box; and
receiving, from the set top box, an address resolution reply.

20. The method of claim 18, wherein performing a synchronization transaction with the set top box comprises:
sending an identity request to the set top box; and
receiving, from the set top box, an identity reply.

21. The method of claim 18, further comprising:
sending at least one erroneous message to the set top box; and
observing, from the first protocol stack, a response from the set top box, wherein the response includes an error code.

22. The method of claim 21, further comprising:
providing the error code to at least one of a log module, a network management module, and a user interface.

23. A set top box for communicating with a headend controller, the set top box comprising:
a network interface operatively coupled to a local area network and at least one customer premises equipment, the network interface configured to provide data communication with the headend controller;
an emulator media access control state machine configured to observe the data communication with the headend; and
a media access control state machine configured to send and receive at least one media access control message.

24. The set top box of claim 23, wherein the network interface comprises a first portion coupled to the local area network and a second portion coupled to the at least one customer premises equipment.

25. The set top box of claim 24, wherein the first portion comprises a first ethernet interface, and the second portion comprises a second ethernet interface.

26. The set top box of claim 23, wherein the network interface comprises an ethernet tunnel port.

27. The set top box of claim 23, wherein the at least one customer premises equipment comprises one of a computing device and a display device.

28. The set top box of claim 23, wherein the emulator media access control state machine is further configured to simulate RF MAC messages using an ethernet MAC.
